(19) United States
(12) Patent Application Publication
(10) Pub. No.: US 2013/0262242 A1
(43) Pub. Date: Oct. 3, 2013

(54) Method and Apparatus for the Handling and Aggregation of Multimedia Contents, for the Creation and Distribution of Multimedia Aggregates and the Distribution of the Associated Advertising Revenue

(71) Applicant: ETALIA SA, Lugano (CH)

(72) Inventors: Nicola Alex Tateo, Paradiso (CH); Aldo Pietro Domenico Daghetta, Vigevano (IT); Claudio Matricardi, Pregassona (CH); Andreas Zumthor, Pregassona (CH); Michele Gonella, Lugano (CH)

(73) Assignee: Etalia SA, Lugano (CH)

(21) Appl. No.: 13/852,846

(22) Filed: Mar. 28, 2013

Related U.S. Application Data
(60) Provisional application No. 61/616,898, filed on Mar. 28, 2012.

(51) Int. Cl. G06Q 30/02

(52) U.S. Cl. CPC G06Q 30/0276
USPC 705/14.72

(57) ABSTRACT

An apparatus for the handling, creation and distribution of multimedia aggregates, includes: modules to store and organize data and user profiles for registered users, to store multimedia content and content profiles in a content database, interfaces for: use of multimedia contents, and for performing searches on the content database, to generate dynamic custom pages and/or static custom pages including the multimedia content, and advertising contents, allowing the publication or display of the dynamic custom pages or static custom pages created; and for content creation, and to let the multimedia content to be inserted in the content database; and for advertising entry and purchasing, and for entering the advertising content in the content database and insert advertising content in the dynamic custom pages and/or static custom pages on the basis of the result of an auction mechanism.

### CROSS-REFERENCE TO RELATED APPLICATIONS

This application claims the benefit of U.S. Provisional Application No. 61/616,898, filed Mar. 28, 2012, which is incorporated herein by specific reference.

### FIELD OF THE INVENTION

The invention relates to a method and apparatus for the handling and aggregation of multimedia contents, for the creation and distribution of multimedia aggregates, through which the contents can be distributed online in aggregated or individual form, allowing the re-aggregation of other users who can participate this way to the distribution of the advertising revenue, and through which advertising messages are distributed in a selective way, according to targeting criteria of the users processed by the system.

### TECHNICAL FIELD

Systems of selection and aggregation of information content are known, either manual or electronic, for example towards the creation of press review.

Manual systems are based on human interaction, but obviously provide arbitrary solutions, non-scalable for any number of users.

Known electronic systems provide solutions that only partially address the problem of processing and aggregation of information content for the creation and distribution of aggregated information, not allowing a real and substantial freedom in choosing subjects to be involved (both as contributors and as users), or in the scalability of the solutions to be adopted for an arbitrary number of users.

The known systems are limited by the lack of- or ineffective integration of automatic categorization tools (especially semantic), thus requiring the presence of intermediaries for manual categorization and organization of information: this intermediation poses problems of independence, impartiality and potential control of the information distributed by the system.

The known systems do not enhance the user's role in the dissemination of published content and do not let him share the revenues deriving from the publication of advertising combined to content.

The known systems are also limited by the lack of- or ineffective integration with content from non-traditional sources (social networks, internet blogs, forums), the importance of which has acquired increasing importance in recent times.

Finally, they are inherently limited by the lack of a business model that effectively remunerates the content providers; this limits and threatens the availability of the same content.

### SUMMARY OF THE INVENTION

The purpose of the present invention is to propose a method and apparatus for the processing and aggregation of multimedia content for the creation and distribution of multimedia aggregates, adapted to face and solve the above described problems.

The method and apparatus of the invention introduce an effective business model able to compensate both the content providers and the intermediaries who added value and helped in the generation of further revenue.

The object of the present invention is therefore to create a database of multimedia content (text, photographs, graphics, video) coming from a variety of selected sources such as (but not limited to) newspapers and magazines, television and radio broadcasters, press agencies, websites and blogs.

The tools offered by the present invention make available all content—free or paid, depending on the choice made by the source—through a single interface, allowing users to search the content simultaneously without having to visit the Web sites of individual publishers or subscribe individually to several subscription services.

The majority of content, where available, is published in full; other content may present in form of links or references to third party websites. The user is able to create his own “newspaper”, as aggregate information, assembling content from different sources, and selecting the desired layout order according to various criteria: author, source, period of publication, and so on.

The user can also publish for free his own contents, which will be inserted into the digital database platform, and include them in his “newspaper” that can then be shared with other users. This newspaper (also defined “journal” in the following) customized by the user can be managed through a virtual “editorial staff” in which each user is assigned the necessary permissions to manage a particular activity.

It is also an object of the present invention the creation of a web platform for publishing media content that can be partially open to modification by the private developers. The system will assume direct management of the platform and keep some sections protected, such as the content and the registered users databases, possibly making available to third-party developers the technical information necessary to develop their own changes and improvements to the platform.

Users are able, where appropriate, to develop plug-ins for viewing content, alternative to those provided by the platform, such as special interfaces for navigation within the platform, applications for the use of content via the web or mobile devices, etc. Such a possibility of contributions by third-party developers will be accordingly subject to verification of the necessary security limits and access to protected databases managed by the system.

It is a further object of the present invention a system which allows the efficient selection of media content within a single database. The platform provides its users with a tool to search the entire database of content from selected sources or published by the users, based on what the user typed into the search field. The search results can be sorted by relevancy factors identified and modified in real time by the user, who can thus set, separately for each search, the criteria highlighting the most important news.

Thanks to the use of sophisticated instruments of semantic search, the platform can be able to identify not only the presence of individual words entered by the user within a content, but also to identify the relevance of the content with the subject sought; this way the content that are closest to the user's request and the content dealing with issues potentially related can emerge in the search results.

Once the search results are achieved, the user has two modes of interaction available. The first mode converts the search into a “dynamic” journal page, thus saving all the search criteria: these criteria will be reapplied to the contents database whenever the page is reloaded. Results may change over time if new contents that meet the criteria are added to the database. The user can see the new content matching the provided criteria by accessing the journal in the corresponding page.

The second mode enables the creation of a “static” page which, instead, allows the user to manually select the content of his interest (using the categorization system described below) and to include it into his personal journal, with a desired layout, possibly integrating with content from other researches or produced by himself. The “static” page does not vary over time unless it is modified by the user himself.

The journals thus created, potentially consisting of both types of pages, can be made public to be shared with other users and searched by the proper tools provided by the platform.

To assist the user in the task of selecting individual content of interest, a labeling tool is available allowing to associate each content with one or more “stamps”, previously created by the user. In this way the user can easily gather contents into groups identified by the stamps, making possible a more rapid consultation (also at a later time) and any use within static pages in his own journals.

A similar labeling system also applies to journals, which can be associated with “stamps” to facilitate the gathering into different groups. The journals so labeled will appear in a separate summary screen, which is unique for each user.

It is a further object of the present invention a system of improvement of advertising models (online advertising) generally used on the web, applied to a platform of publication of information contents. The system of publication of ads made available to the advertiser allows to plan the purchase of advertising space related to both the content of the page viewed and the profile of the user viewing it. The users targeting system is particularly advanced in that, unlike other models currently known, is based on both demographic data and individual preferences declared by the user, and the automatic analysis of his usage habits by the platform (topics and categories most read, preferred sources, etc.). Thanks to this information the advertiser is able to reach with his ads an audience more selected and consistent with his target.

The assignment and purchase of advertising is made through a software system that automatically detects the available space on the platform, based on the demands of the advertisers and on the parameters (such as the target audience) set by the advertisers, assigning them automatically through a real time auction system, such that each advertising space is assigned to the advertiser who placed the highest bid.

The present invention also solves problems inherent in the known solutions. It proposes a scalable system for an arbitrary number of users equipped with a very simple user interface, solving the typical complexity of the known systems. It provides an electronic tool applicable in real-time to an arbitrary number of content, while maintaining the effectiveness in filtering the information according to the constraints defined by the user: thus it overcomes the limitations of current research with an advanced search engine that allows the user to define different and varied criteria.

The present invention also solves the problem of management and control of the rights associated with the content (copyright). From this point of view the platform provides an electronic system that ensures profitability to the authors or right holders. The user doesn't have to worry about the possible violation of existing copyrights or about the remuneration of the right holders, because that is attended to by the system. The system solves the risk of copyright infringement by the users, by creating a database of content accessible on the basis of a licensing system through which, in the case of premium content, the privileges of access and reading are available only to readers who have purchased the content itself in one of the ways (such as micropayment or subscription) set by the author of the content.

The present invention also solves the problem of integrating new ways of disseminating information that are more efficient and targeted to the purposes and interests of users: for example, by providing the user with only the interesting information, removing the need to purchase the entire journal if the object of his interest is only a small part of it. The sale of the single content as well as the sale of the contents in separate selections is allowed, encouraging the circulation of content.

It is an object of the present invention to provide an apparatus adapted for the handling, creation and distribution of multimedia aggregates, comprising:

a first database module, adapted to store and organize data for registered users, and to generate user profiles associated to each of said registered users,
a second database module, adapted to store multimedia content in a content database, and to associate content profiles to each of said multimedia content,
a first interface adapted for use of multimedia contents, and adapted to perform searches on said content database, to generate dynamic custom pages and/or static custom pages including said multimedia content, and including advertising contents associated with said multimedia content, said interface for use of contents allowing the publication or display of said dynamic custom pages or static custom pages created,
a second interface adapted for content creation, and adapted to let said multimedia content to be inserted in said content database, and assigned to said dynamic custom pages and/or static custom pages, said dynamic custom pages being updated automatically based on selection and sort criteria set by the user, said static custom pages being organized in specific selected sort order, position and size,
a third interface adapted for advertising entry and purchasing, and adapted to enter advertising content in said content database and insert advertising content in said dynamic custom pages and/or static custom pages on the basis of the result of an auction mechanism, said multimedia aggregates comprising said dynamic custom pages and/or static custom pages.

These and further objects are achieved by means of an apparatus and method as described in the attached claims, which are considered an integral part of the present description.

### BRIEF DESCRIPTION OF THE DRAWINGS

The invention will become fully clear from the following detailed description, given by way of a mere exemplifying and non-limiting example, to be read with reference to the attached drawing figures, wherein:

FIG. 1 shows a block diagram of the high-level logic flow chart of the apparatus in accordance with the invention;

FIG. 2 shows a block diagram of the function relating to the ways in which the information or content enter the apparatus;

FIG. 3 shows a block diagram of the function relating to the ways in which the user can enjoy the content of the apparatus;

FIG. 4 shows a block diagram of the function of the search engine applied to “Content Search” block of FIG. 3;

FIG. 5 shows a block diagram of the function of determination of profiles “Profiling process” of FIG. 1;

FIG. 6 shows a block diagram of the “Advertising” function of FIG. 1;

FIG. 7 shows a block diagram of the component “Crawler” of FIG. 2;

FIG. 8 shows a block diagram of the various software components of the apparatus;

FIG. 9 shows a block diagram of an example of an hardware infrastructure of the apparatus;

FIG. 10 shows a block diagram of the function of Publication creation, FIG. 1;

FIG. 11 shows a block diagram of the function of license checking, FIG. 3.

### DETAILED DESCRIPTION OF EXEMPLARY EMBODIMENT

The invention will now be described first in general terms, then with reference to the accompanying figures.

In the present contest, the apparatus or system is also defined platform.

As already indicated above, the invention proposes a platform through which the information content can be distributed online, in aggregated or individual form, allowing the re-aggregation by other users.

In the following the multimedia content will be intended as contribution for insertion into the multimedia aggregates.

In addition, the platform includes a system to allow the distribution of the advertising revenue generated by the content not only to the content supplier himself (author or publisher), but also to any user who added value and/or contributed to the circulation of the content, promoting and/or resulting in the generation of the revenue.

The platform according to the invention comprises some basic parts, interacting with each other to ensure the proper functioning of the system:

User database.
Content database.
Interface of use of contents.
Interface for content creation.
Interface for advertising entry and purchasing.
These components are described below functionally.

### User Database

The user database stores and organizes data for all registered users: even if the platform can be used by non-registered users, registration allows to take full advantage of its potential. Unregistered users are not able to publish such content or purchase paid content.

Anyone wishing to use the platform to publish content, must complete the registration process, which leads to the creation of a personal not transferable account.

The registration procedure involves the provision by the user of a set of personal data, in addition to any data of payment and billing.

For each account created in the user database, the system generates a user profile associated with it that will store the data of the user's behavior, including:
Preferred sources.
Preferred reading topics.
Content created and read.
Journals created and read.

These data are both derived from the analysis of user behavior on the platform, and in some cases explicitly declared by the user.

Users can create additional profiles, so that the individual user accounts associated with them will be linked to more user profiles—i.e. multiple sets of preferences (for example in terms of sources, authors, topics and favorite places). Using the system, the users can take in real-time one of the profiles in their account (for example, choosing between profile “Leisure” and profile “Work”), resulting in different experiences of use of the platform.

For each user account created in the user database, the system generates a standard journal associated to it, intended as the preliminary default journal, containing a first example of multimedia contents aggregate as explained later.

Registered users who wish to publish content can do so in various ways, including:
Direct manual entry (write / create) through an input interface;
Supply through RSS FEED tool from existing web source;
Entry by robot acquisition personalized for the acquisition of content from third-party servers (for example, the archive server of a publisher): this mode will be developed specifically for each content provider, subject to specific agreement.
Entry using Content API.

The last three procedures will be agreed through direct agreement with the managers of the system.

### Content Database

All multimedia content included in the platform are copied individually in a specific database. Each content is associated with a number of parameters, among which:
Name of the source (user account),
Date of publication.
Pertaining Journal.
Possible cost.
Possible categorization information added by the supplier.
Possible associated media content.

At the acquisition, the database associates each content with a content-profile which can store a set of data relating to the content, so as to enable an easier search and identification.

When creating the content-profile the database starts a process of automatic indexing by means of semantic analysis: to the purpose the software solution Cogito ®, of Expert System, is used. The process returns a set of information relating to the content, among which:
Main topics covered.
Bodies appointed (people, places and geographical coordinates, company).

Such information is stored in the content-profile associated with the content.

At the same time the database starts another process of automatic indexing based on full-text logics, which leads to the extraction of new information associated with the content. Among them:
Keywords used.
Keyword density.

This information is further added into the content-profile associated with the content.

Based on the content-profile obtained, the database will possibly produce a summary of the content that highlights the most important sentences. In this case the summary would be automatically generated for all the textual content entered and could possibly be modified by the publisher of the content or the person who has the necessary rights of access and control, assigned by the same publisher.

The database will also allow the inclusion of any comments made by users, which can be further element of categorizing the content and contribute to find it in searches.

All contents recorded on the database are then provided with an individual profile containing all the information coming from the semantic indexing engine, from the full-text indexing engine and any further indexing.

### Interface for Use of Contents

The user can access the content database through a user interface.

The interface allows to search within the content database. Each search can be conducted for key fields such as:
Topic/place.
Keywords.
Date.
Source.
Type of content.
Language.

Every journal, starting from the preliminary standard journal created when the user registered to be associated to his account, basically comprises assembled pages including dynamic custom pages and/or static custom pages, defined in the following, each aggregating multimedia contents.

Every search made by the user generates a new “dynamic” custom page: this page, corresponding to the search criteria expressed by the user and continuously updated, reflects the availability of content that meet the criteria.

The interface also allows the creation of “static” custom pages: the user can find and individually select the content to be added to the page, from among those previously collected through the system of “stamps” described above: the page thus contains all and only the content individually selected by the user. Such content can be paged manually by the user via a graphical interface that allows direct placement on the page, or automatically by means of a set of automatic layout plug-ins provided by the platform or possibly created by third-party developers.

The interface allows the display of advertising associated with the content directly within the pages of journals, on the basis of the result of an auction system.

The interface allows the publication or display of the created journals.

The user can set the journal to be:
Personal: accessible only by the user who created it (the author).
By invitation: only accessible to users explicitly invited by the author.
Public: open to all.

The interface allows to share the papers with other users of the platform. At the creation, the journal has only one author (who is also the owner): the author may involve others in the journal administration, structuring an editorial staff in which different users are assigned different roles (reader, writer, editor or director), each with different privileges and access control:
Reader (only if the journal is private): The reader user can access the journal. If the journal is public, it is not possible to define a list of readers, because the journal is already freely accessible by all.
Editor: the editor user can access the journal, create new content and propose it for publication.
Editor-In-Chief: In addition to having access to the journal and to create content, such as an editor, the Editor-In-Chief can verify, correct and publish the journal's pages and all the associated content.
Director: in addition to the privileges of an Editor-In-Chief, the user Director can change the structure and the details of the journal as a whole.
Publisher: This is the user that owns the journal, that is, the user who originally created it: to the privileges of the Director it adds the ability to delete the journal.

The interface allows to search journals created by other users.

The interface allows to search for other users.

The interface allows the user to access the summary screen of his profile from which he will be allowed to modify any information, including:
Reading Preferences: for example, preferred source, authors and topics.
Personal data.
Economic data and billing information.

The interface allows the user to filter and sort the contents of journals through the profile of another user, if that another user has granted the possibility of such use of their profile.

### Interface for Content Creation

The interface for content creation allows the insertion by the user of a content directly in the content database, through a word processing and editing tool.

The user can enter information such as:
Text of the content.
Title.
Subtitle.
Multimedia associated elements (images, video).
Any additional tag for the categorization of content.

The user can assign the contents to a journal among those for which the user has the necessary control privileges (i.e. the journals he owns or those in which he is an editor, an editor-in-chief or a director). The user can publish his own content for free or on sale, by defining an individual sale price. The user can also aggregate multiple contents by a journal and then sell the contents jointly by defining a journal sale price.

In any case, the user can determine how to publish the content in the journals he owns, reorganizing them into “dynamic” Pages, updated automatically by the platform based on the selection and sort criteria chosen by himself, and/or into “static” pages prepared directly by him, in case manually selecting the sort order, the relative position and size within each page. The same conditions apply to any content present in the database of the platform, even if carried out by other authors.

The user can also decide whether to make the content he owns searchable within the platform by means of the system tools, or alternatively to deny the search function. In the latter case, the content will be accessible only through the page of the journal in which the content has been published, or in journals where other users manually aggregated it.

### Interface for Advertising Entry and Purchasing

Each user interested in buying advertising space must register by means of a dedicated interface.

Registration involves the creation of an advertiser account on a dedicated database: for each advertiser user a number of parameters are stored, including:
Personal data.
Economic data and billing information.
Advertising campaigns.

The interface allows the user to purchase advertising space by inserting a new advertising campaign targeted to the content and users of the platform.

When entering a new advertising campaign, the advertiser must set certain parameters, such as:
Type of advertisement.
Graphic format of advertising.
Any destination internet address of the advertising message.
Image or multimedia item subject of the message.

For each advertising campaign included the user can then set:
Name of the campaign.
Brand of reference.
Date of start and end of the campaign.
A set of additional images or multimedia elements associated with the campaign.

The user can define a distribution channel, i.e., a set of constraints on the type of content associated to the advertising, including:
Topic of the content.
Source who provided the content.

The advertiser user can define the target campaign, i.e., the set of socio-demographic constraints for users who will display the advertising.

The advertiser user must also define the economic characteristics of the campaign:
Type of the campaign (display or performance).
Total budget allocated or daily budget for a defined period of time.
Maximum buying offer of a single package of views and/or performance.

The above cited parameters are stored by the platform in a profile associated with the campaign created by the advertiser user.

All campaigns with their individual profiles are stored in a dedicated database relating to the advertising insertions on the platform.

In the following the invention is described in detail with reference to the attached figures.

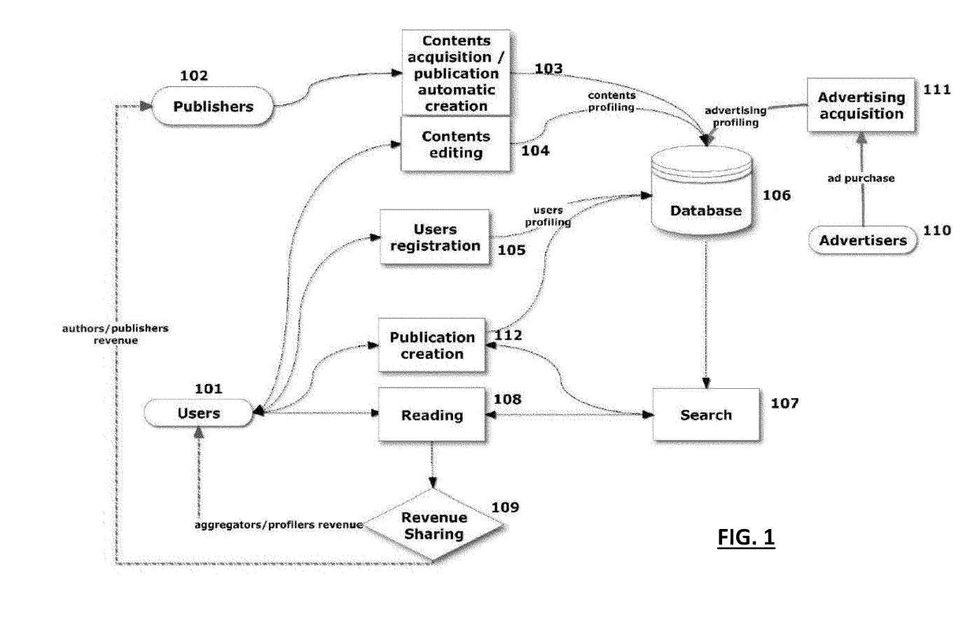

With reference to FIG. 1, the high-level logic flow chart is described that characterizes the constitution and mode of operation of the platform of the invention.

Three types of entities can access and use the platform:

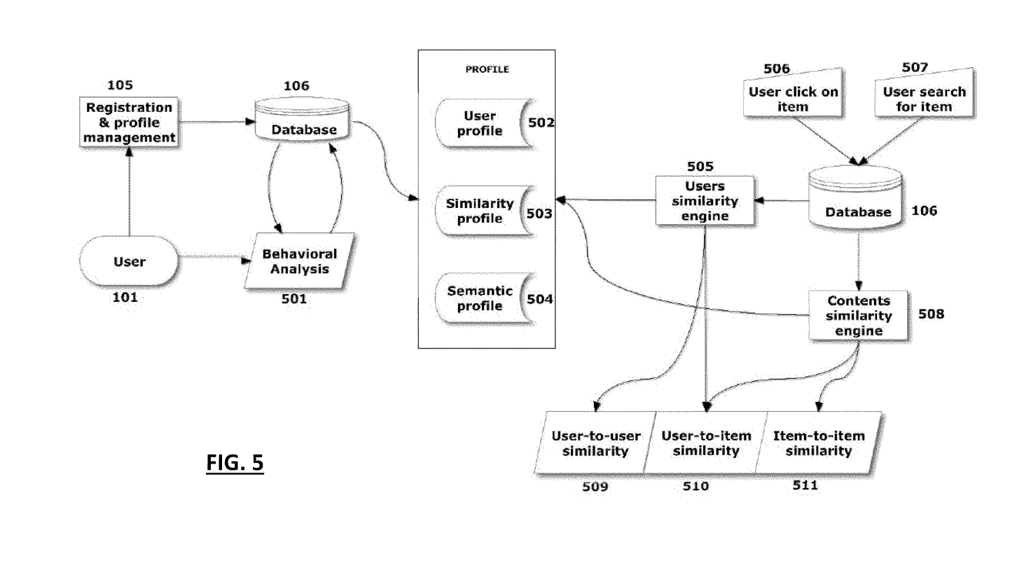

The first type is the “Users” 101 who need to register, qualify, add information about their fields of interest, “user registration” 105: the system creates an account “user profiling” using both user-entered information, and those processed by the platform for each user (see below FIG. 5), also in a dynamic way.

The second type comprises the authors or publishers, agencies “Publishers” 102, who provide content, documents, publications, multimedia content (images, video, etc.) and text.

The contents are introduced into the platform via the function of block “Contents acquisition” 103 or “Contents editing” 104, which acquires them. The authors therefore can directly provide their content to the platform. The system creates an account “content profiling”. The contents are accessible via the block “Reading” 108: by it the users can access content created and organized in papers by other users. A user can create a journal using the function “Publication creation” 112. Even users who have provided content can then act as publishers. The block “Reading” 108 selects the content also through the search engine “Search” 107 and returns the aggregated content in various forms provided by the user, as will be described below.

A third type of subjects relates to the world of advertising: the “Advertisers” 110 buy advertising space on the platform, which will be linked to the read contents, using the function “Advertising acquisition” 111, setting the constraints or parameters they want to be respected, for example, users and/or content target, providing the platform the advertising content that appear in the journal alongside the content chosen by the user. It is the platform that decides how and where to insert the advertising content and not the user who creates the journal.

In addition a further entity is by default the system manager of the platform, as a supervisor of the whole of the activities performed.

The advertising spaces are assigned through a software system that automatically identifies the available space on the platform which meet the parameters specified in the demands of advertisers, and then assigns them, via an auction mechanism, able to allocate the identified space to the advertiser that has provided the greatest compensation for insertion.

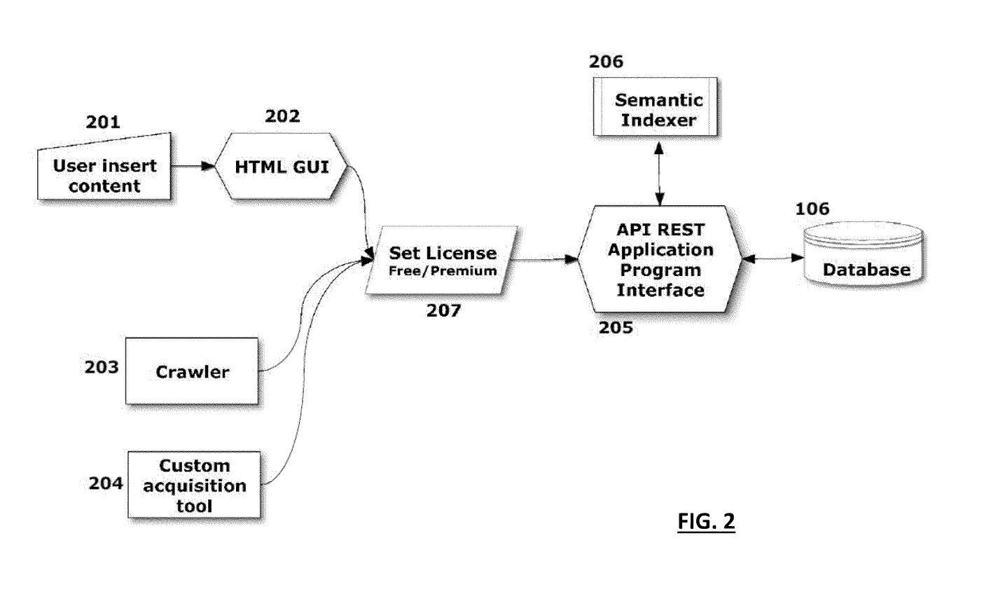

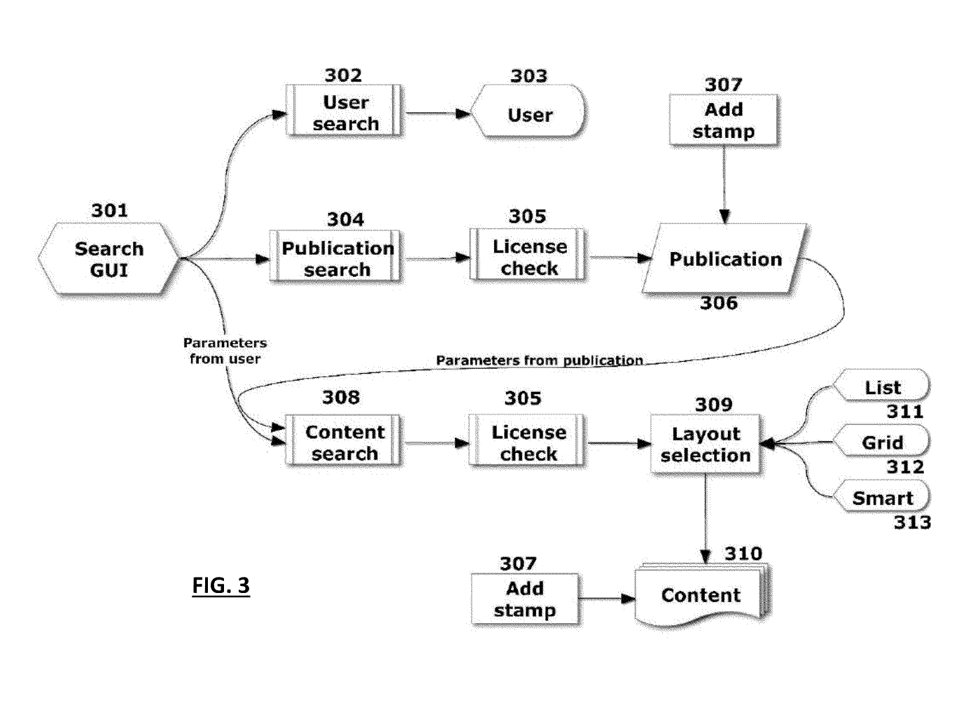

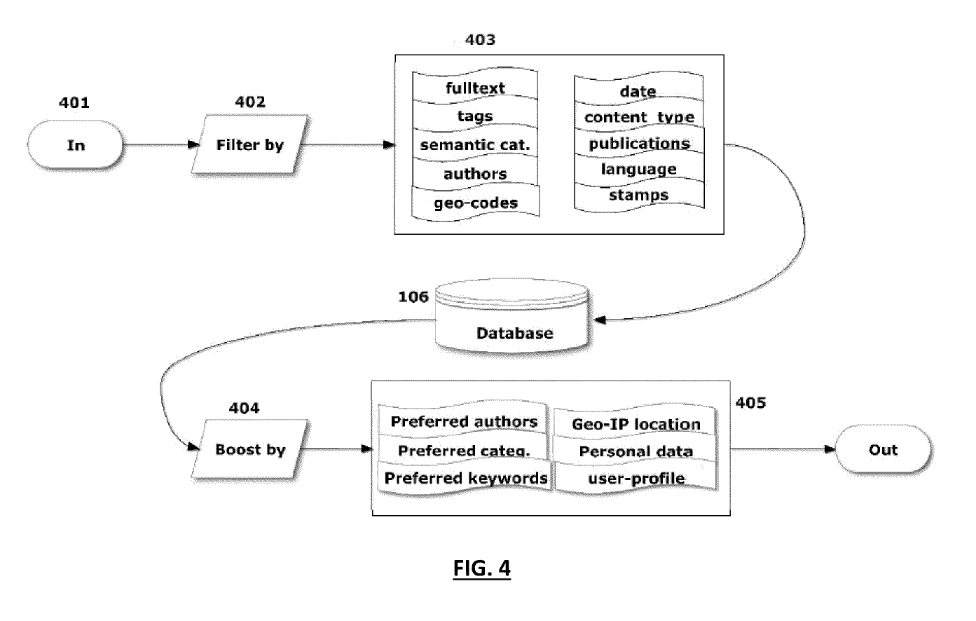

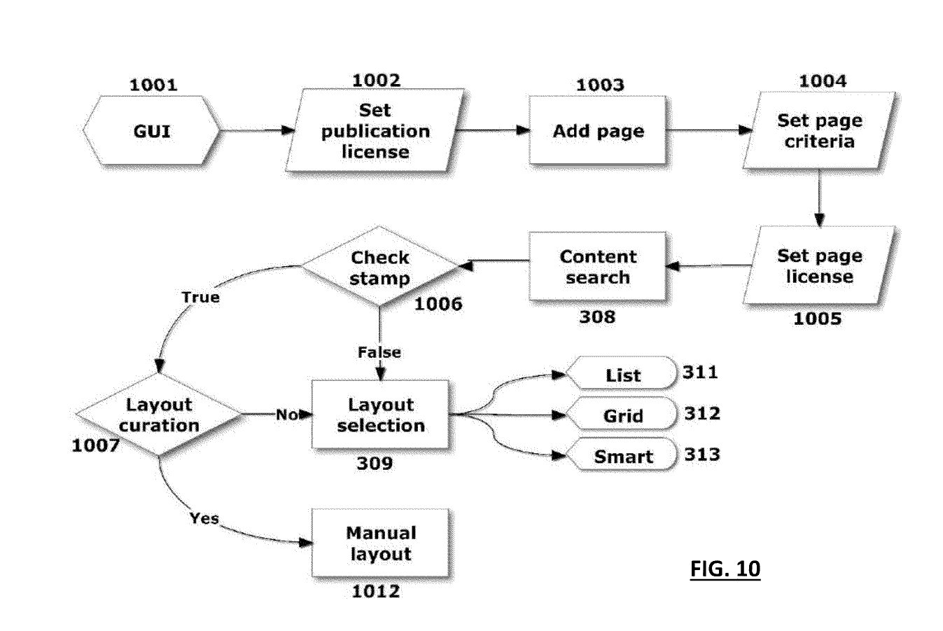

The information and content acquired by blocks 103, 104, 105, and 112 are stored and processed by the platform “Database” 106, as described below. More particularly the blocks 103 (Content acquisition/publication automatic creation) and 104 (content editing) will be described with reference to FIG. 2, the block 108 (Reading) with reference to FIG. 3, the block 112 (Publication creation) with reference to FIG. 10, the block 107 (Search) with reference to FIG. 4.

In addition, the result of reading is used by the platform to calculate the “Revenue Sharing” 109, that is, how to allocate the financial compensation resulting from the spread and use of advertisements among the various parties involved, mainly the authors of the contents introduced into the platform, and users as creators of new papers with the platform.

The calculations to be done for economic compensation, therefore, are of three types:
Auction: Determine the auction of advertising, i.e. who offers the best price for the use of advertising;
Entities sharing that revenue, then determine the involved content and the advertising inserted;
How to distribute the revenues among the authors and users.

Users must pay to buy some specific content (i.e. premium content), which have a specific cost, determined by the author/publisher. Access to the platform is usually free through registration, so the user does not pay if he wants to access only free content.

With reference to FIG. 2, the ways in which the information or content may enter the platform are described.

One way is the user direct reference.

Through the function “User content insert” 201, the user logs in the system, and he can access the screenshots to input data and inserts the contents through the interface “HTML GUI” 202 of the application.

Two other modes are of the automated type.

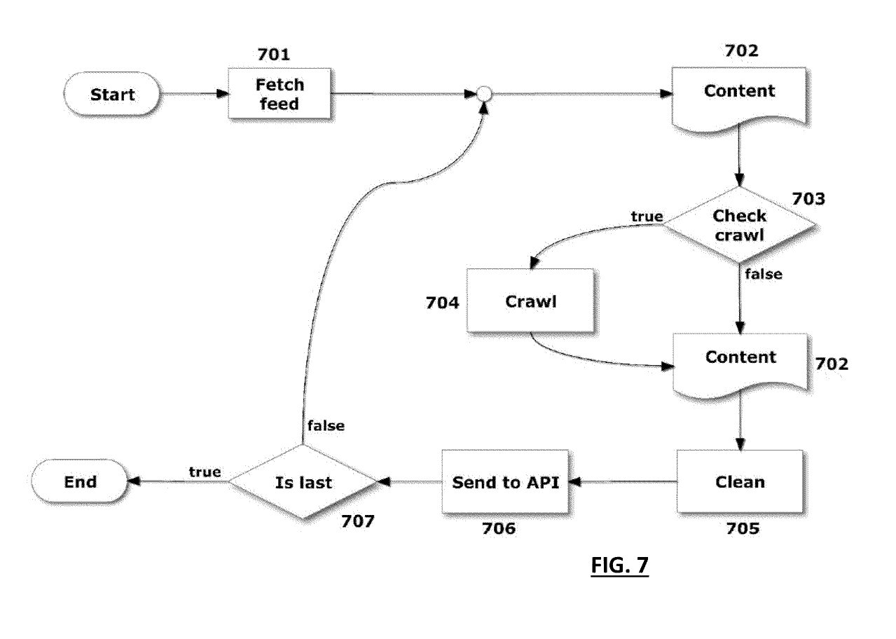

Using the function “Crawler” 203, described in more details with reference to FIG. 7, individual references or aggregated news, rss/atom, upgradeable lists of information, made available by the publishers, or by portals across channels already available on web, enter the platform, such as through standard RSS-FEED, therefore the platform must only engage with what already exists. The original source makes available the address(es) to connect with, to gain access to the FEED with HTTP connection.

Through the function “Custom acquisition tool” 204, content from proprietary database structures, such as large traditional publishers, enter the platform. Custom procedures allow to connect to their server and database with HTTP connection, ad-hoc solutions for individual subjects to interface, e.g. for direct input to the interface “API REST” 205.

The interface “API REST” 205 receives all content from various sources and transmits them to a “Semantic Indexer” 206, which responds by creating a semantic content profile, i.e. a range of information on the topic, organized as a tree of categories.

Among the information coming to the interface “API REST” 205, there are also information about the license to apply to that content “Set License” 207.

Via the interface “API REST” 205, the content and the related semantic profiles are stored in the “Database” 106.

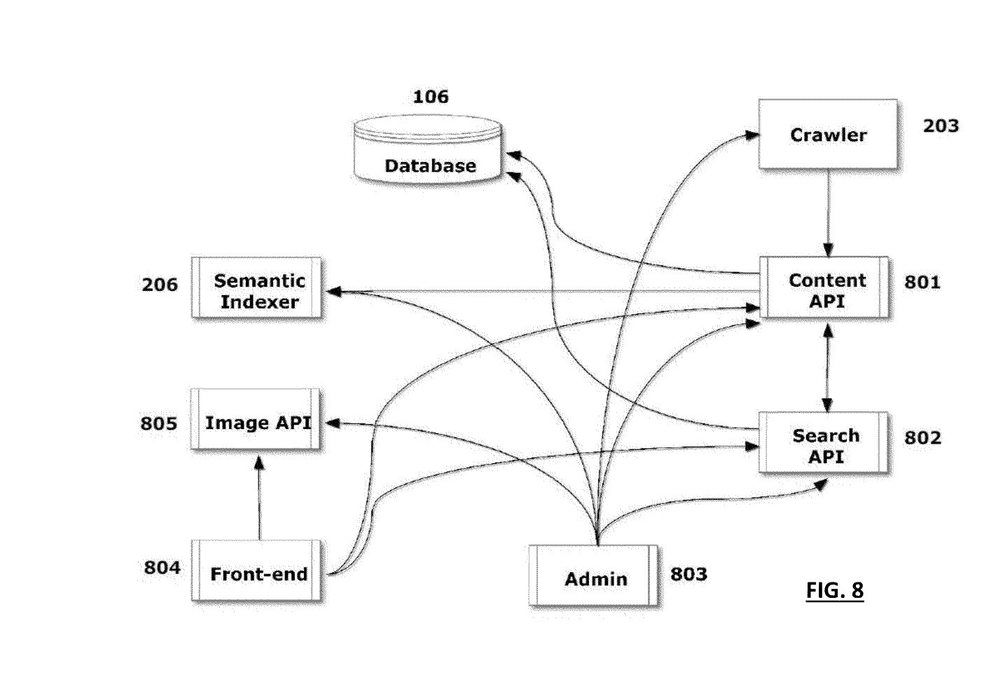

The blocks 205, 206 and 106 will be described in more details with reference to FIG. 8.

With reference to FIG. 3, the ways in which the user can enjoy the content of the platform are described.

By the interface “Search GUI” 301, the user can search the three types of entities:

“User search” 302 allows to search for users by returning a list of users that match the parameters entered; through it the details of the users “User” 303 can be reached.

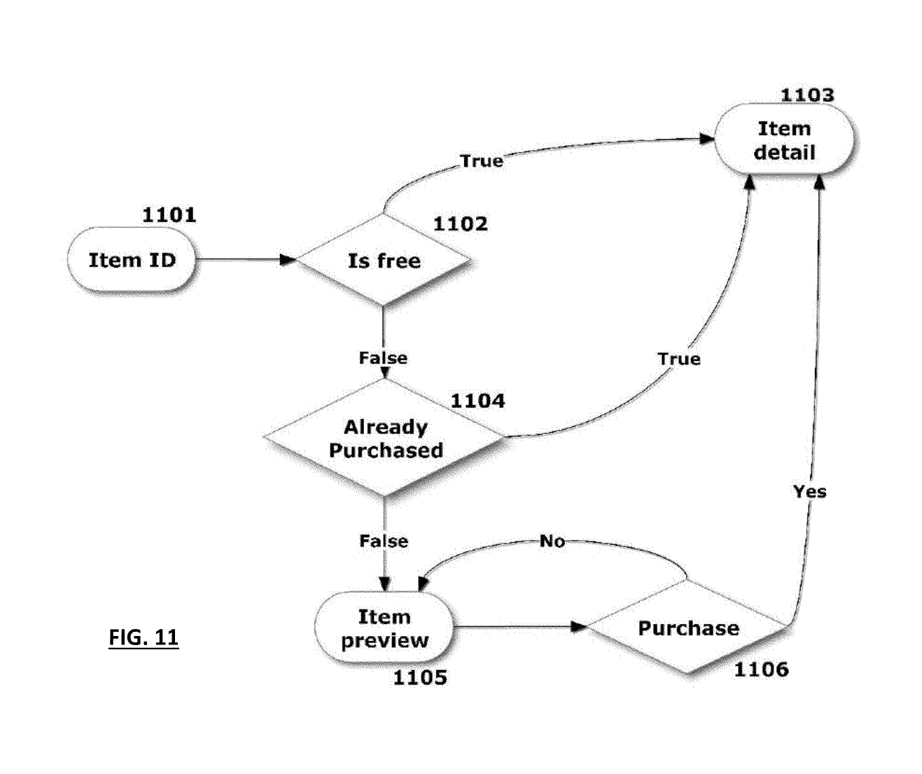

“Publication search” 304 allows to search journals; from the returned list individual journals “Publication” 306 can be reached. To allow this, a first check is made on the license “License Check” 305, described in more details with reference to FIG. 11; then it is possible to apply a Stamp “Add stamp” 307 to the journal. The journal is divided into sections with different contents inside: substantially the contents are chosen through a search (also manual selection goes through a search performed previously).

“Content search” 308, described in more details with reference to FIG. 4, allows to search through the contents. From the list it is possible to access the individual content “Content” 310, after passing the license check “License Check” 305. It is proposed a default list view, but the user can select a list among those provided by the platform, through the function “Layout Selection” 309. Among the lists there are:
a) “List” 311: a minimal display to maximize the number of content on the screen.
b) “Grid” 312: a grid view.
c) “Smart” 313: a display that clusters the content on the basis of similarity algorithms.

A stamp “Add stamp” 307 can be applied to a content.

With reference to FIG. 4, the function of the search engine applied to content “Content Search” is described.

The search engine accesses the “Database” 106 by performing a search of content by a two-step procedure, first filtering them through the parameters 403; then the result is sorted by the “Boost by” 404 function, using the information 405, some of which are part of the “Profile user” (block 105 FIGS. 1 and 5).

The filtering function “Filter by” 402 has the function to exclude some content over others. In block 403 some examples of types of filtering are shown: full text, words that appear in the content, author name, date, semantic categories (found with the “Semantic Indexer” 206), tags (labels, i.e. keywords added by the user for the specific search), language, stamps applied, et al.

Instead, the sort function “Boost by” 404 acts as a consequence of operations carried out by filtration, to establish a ranking of importance of various selected content, only ordering by importance, without exclusions. The user can decide which are the factors that determine these choices, providing a sort of importance, for example giving priority to the choice of authors or sources etc.

With reference to FIG. 5, the function of determination of profiles “Profiling process” is described in more details, connected to the function of the search engine “Search Engine”, already mentioned above with reference to the operations of “Contents profiling”, “User profiling” of FIG. 1, for the creation of the “Database” 106.

All profiling information are then used by the platform in the manner already described, for the creation of journals by content aggregation.

Events determined by the user, such as clicking on a content and search, activate the process of profiling of the user, through an analysis of his behavior, “Behavioral Analysis” 501 with known processes: text analysis, semantic analysis, navigation preferences and personal data of the user are collected and used to generate the reports described below in detail:
Similarity between users;
Similarity between users and content;
Similarity between content.

The user profile “User profile” 502, which contributes to the creation of the “Database” 106 is built mainly with two types of information:
The details of his master data: they can also be used as search criteria;
The preferences already expressed by the user, also as behavior and interests, which contribute to define the “Boost by” 404 search engine (FIG. 4).

There are also provided a series of operations that calculate “distances” between objects. In particular three types of distances are calculated:
Distances between users “User-to-user similarity” 509, i.e. the level of similarity of the profiles of the users,
Distances between the various content “item-to-item similarity” 511, i.e. the level of similarity of the various content, for example to avoid providing content too similar to each other,
Distances between users and content “User-to-item similarity” 510, i.e. the extent to which the subject responds to the content of the prevailing user interests.

For the calculation of distances, a system of vector numerical calculation of n-dimensional differences among various objects is used, which performs these calculations in real time and updates them according to updates acquired from the platform.

The measures of the three distances can be made by using:
An engine that measures the similarity of users “Users similarity engine” 505, which in turn uses also the history of navigation criteria that each user has used, including the list of choices of content “User clicks on item” 506 and search criteria “User search for item” 507;
An engine that measures the similarity of contents “Contents similarity engine” 508, which uses the content database 106.

The engine that measures the similarity of users 505 provides as a result profiles of similarity of users 503, while the engine that measures the similarity of the content 508 provides as a result semantic profiles 504. These results are used by the search engine.

Returning to operations that calculate “distance” between objects:

The similarity between users “User-to-user similarity” 509 is calculated using navigation data of the user: for each click on the content the platform intercepts the source of editorial content, the IPTC categories extracted by the displayed article, the keywords contained in the text, the localities mentioned in the text and its geocoding, names and organizations. For each of these categories of data, a scale of importance percentage is constructed, which represents the so-called average profile of the user. The “scale” of each user is stored on a database, indexed and used for comparison with other “scale”: the comparison shows the greater proximity of two users with respect to the average profile of navigation. Similarity in the “User-to-user similarity” 509 also includes significant personal data (personal or behavioral) and participate to the comparison of user profiles on the basis of a platform configuration;

Content also build an average profile, based on the user who is currently viewing it. The profile changes constantly increasing and decreasing in the percentage values of its “scale”. When searching for articles similar to user profile “User-to-item similarity” 510, a comparison is made of the indices of the average profile of the user and the content. The indexes are constructed by generating a model of article that contains all the data of navigation aggregated into a single text used to calculate the vector distance between strings.

The direct similarity between the content of “Item-to-item similarity” 511 is the case for the indices extracted by the semantic search engine and by textual index, bringing out both similar content (higher percentage in the calculation of the index text) and related content (that express just the same keywords, the same categories IPTC and entities).

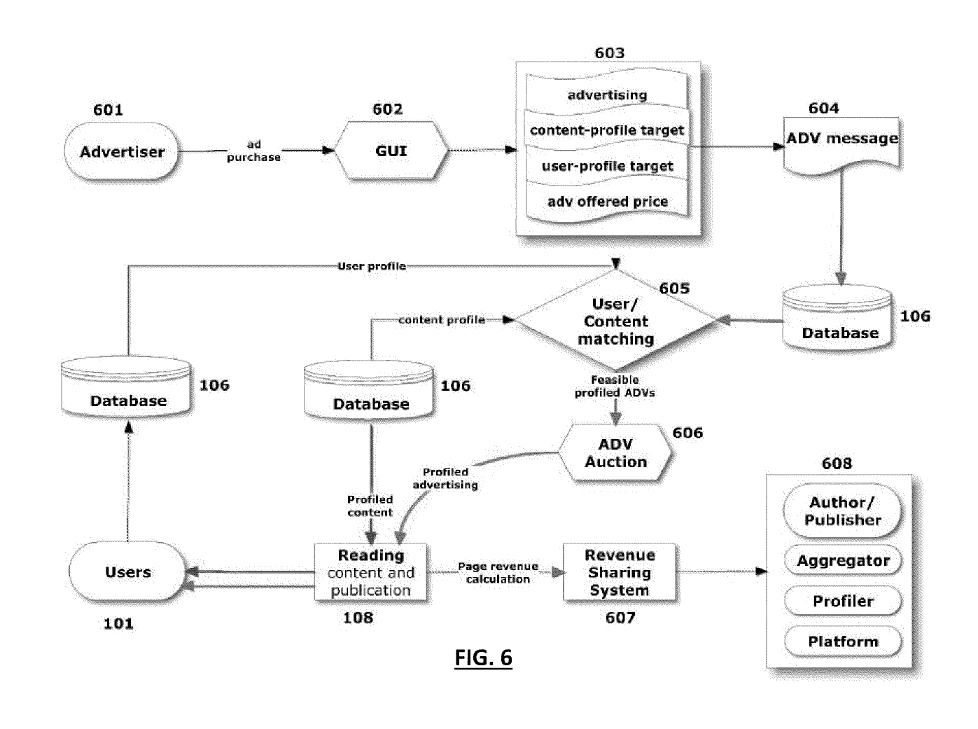

With reference to FIG. 6, the “Advertising” function, cited above with reference to FIG. 1, of acquisition and use of advertising content, is described in more detail.

The advertisers “Advertiser” 601 have a graphical interface “GUI” 602, independent from that of the users, to interact with the platform. The same user of the platform can also appear as a subject of the advertisement.

Through the graphical interface “GUI” 602 the information 603 to compose advertising messages “ADV Message” 604 are requested:
Define the advertising message “advertising”, i.e. enter the message in the desired shape, such as text, images, video;
Define the target, both as “content-profile target” and as a reader “user-profile target,” that is to delimit the target to which the advertisement has to be sent;
Insert the reward offered “adv offered price” for the publication of the message.

The advertisement follows an independent path in the platform, in the sense that the user does not see it when composing its aggregate content; the system adds it automatically reading it from the advertising database 106.

The system first selects the set of advertisements that may be suitable for inclusion in the page of the journal, performing comparison operations between advertising messages and features of content and user “User/content matching” 605, read from the “Database” 106 created with equivalent procedures to those described above.

Then the system calculates, for each page open by the reader, what is the advertisement to be added to the page that offers the highest reward, via an auction mechanism “ADV auction” 606 that considers a set of parameters related to the type, the characteristics of the advertising message and the relevant advertiser: the message thus identified as the best one is finally inserted into the page, using the above described procedure (FIG. 1, block “Reading” 108) of the overall composition of the journal.

For every advertisement inserted, the system calculates a distribution of the compensation offered for the delivery of the message “Revenue sharing” 608, between the various types of users involved in the system 608: the authors or publishers “Author/Publisher”, user “Aggregator ” who created the journal, the user who provided the profile used “Profiler”, and the platform.

The advertising revenue is shared among the platform and the content's contributors, meaning not only the content's provider but also the intermediary users who added value by contributing to the content's circulation and by enabling the advertising revenue generation.

In details, the following cases are possible:

1. The user-reader A has access to the content either direct (by a content search) or by the original journal it was published on (owned by the same user-publisher as the content; the content's publisher receives a given percentage of the associated advertising revenue.

2. The user-reader A has access to the content through the selection (journal) made by user B (the ‘Aggregator’); the content's publisher hands over a share of his advertising revenue to the user B, as compensation for his selecting role which contributed to the revenue generation

3. The user-reader A has access to the content by using another user's profile (user C, the ‘Profiler’); the content's publisher hands over a share of his advertising revenue to the user C, as compensation for his profile sharing which contributed to the revenue generation.

4. The user-reader A has access to the content through the selection (journal) made by user B, by using another user's profile (user C); the content's publisher hands over a share of his advertising revenue to both the user B and C, as reward for their contribution to the revenue generation.

In all cases, the platform keeps a fixed and minority share of the entire advertising revenue.

With reference to FIG. 7, it is described the behavior of the component “Crawler” (203, FIG. 2): it starts with the reading “Fetch feed” 701 of the public feed; for each post “Content” 702 contained in it, repeated for every post “is last” 707, it checks whether it is full or not “Check crawl” 703, and possibly recover the page containing the full article “Crawl” 704. Then a number of operations are performed for trying to keep only the relevant parts of content (text, images, etc.) “Clean” 705. Once a clean and complete content is obtained, it is sent to the “API REST” 205 by using the function “Send to API” 706.

With reference to FIG. 8 the various software components of the infrastructure are described.

“Database” 106: it takes care of saving the data of the platform: it is divided into several parts that make use of different technologies. In some cases information are replicated in multiple databases and synchronized to allow the reading access in the shortest possible time. Access to it only the Content API and Search API functions

“Crawler” 203: deals with recovering news published through syndication in RSS/Atom format and insert them into the platform using the Content API, possibly aggregating them in journals automatically created or pre-created through the application of ‘stamps’.

“Semantic Indexer” 206: deals with the semantic content categorization and analysis of the entities (places, organizations/companies, characters, etc).

“Content API” 801: it performs the task to enclose the main parts of possible interactions with the platform, that is the ‘operational’ components used by the GUI (even those developed by third parties). They include the main parts of the business-logic and functionality, together with the Search API constituting the core of the platform.

“Search API” 802: dealing primarily with performing the search within content, journals and users, to deliver results in the shortest possible time, also with performing analysis tasks for the completion of user profiles based on usage of the platform by the user.

“Admin” 803: is the user interface used by the platform to administer and manage the other components.

“Front-end” 804: includes both the public site of the platform used by the “Users” 101, and the administration of advertising used by the “Advertisers” 110.

“Image API” 805: take care to save, deliver and manipulate images.

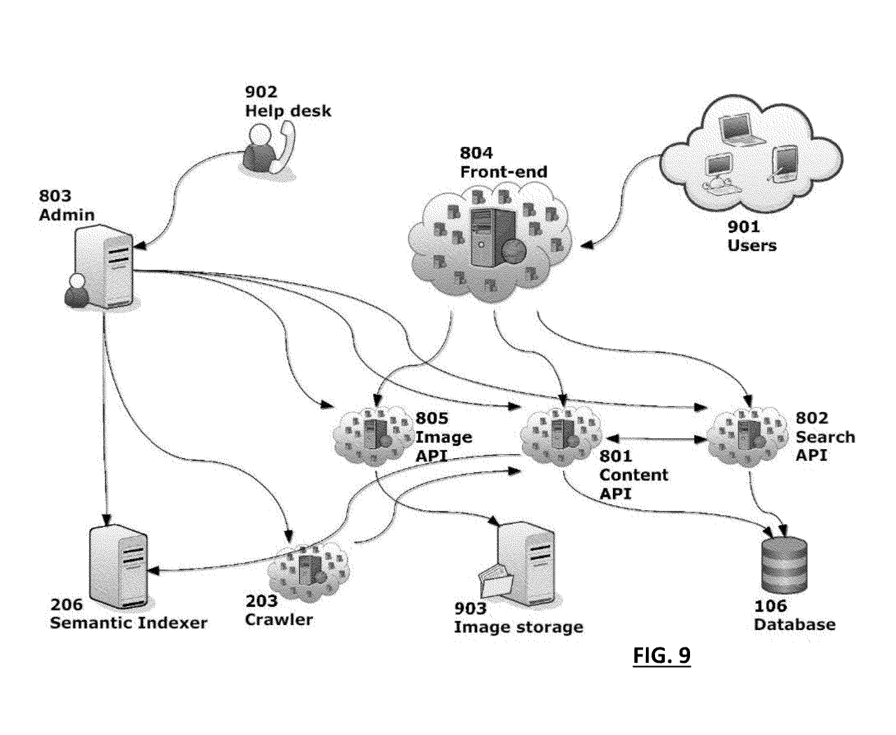

The FIG. 9 describes the hardware infrastructure of the platform. The system is based on distributed and interconnected elements through local or wide networks, using Cloud Computing systems.

The infrastructure provides that all the most delicate components are scalable horizontally both to avoid problems associated with the single server and to provide the services to a greater number of users without delaying the operation. To meet this requirement, auto-scaling systems can vary the number of the available servers, increasing or decreasing the number and the computing power according to the requested capability. The various components are exposed and accessed through load-balancing systems to allow a load allocation equally on each of the servers.

Therefore the access to the platform by the “Users” 901—which include devices such as desktops, laptops, smartphones, tablets and other devices connected to the internet with a recent browser and support of HTML5, CSS3 and Javascript—is through the “front-end” 804. The latter includes both the public interface of the site and the interface of the advertising purchase; the “front-end” 804 part uses all the other infrastructural components (Image-API 805, Content API-801, and Search API 802) to provide the best possible user-experience.

Another part is “Admin” 803, through the function of “Help Desk” 902, for platform internal use to provide support for customers/user; this component uses the infrastructure components directly in order to perform administration and moderation operations that are not available in the public site.

The components of “Image-Storage” 903 and “Database” 106 are the so-called single-point-of-failure; replicated storage systems and distributed or sharing systems or any content master/slave type approach are used to remedy some problems that could occur, both for performance reasons and for information replication reasons, thus to avoid the loss of the same.

With reference to FIG. 10 the process of creating a journal is described (Publication creation 112, FIG. 1).

Through the “GUI” 1001 users “Users” 101 can create a journal indicating among the various information the licenses to apply to the same “Set publication license” 1002. Once this is done the user can add pages to the journal “Add page” 1003, by specifying various criteria for the extraction of content “Set page criteria” 1004 to pass to the search engine in the block “Content Search” 308, and any license to apply to the page “Set page license” 1005. If the criteria specify at least one Stamp “Check stamp” 1006, the user can choose “Layout curation” 1007 to deal manually with the layout of the content “Manual layout” 1008 or use one of the default views provided by the platform, described above with reference to FIG. 3 (blocks 309, 311, 312, 313).

FIG. 11 describes the process of checking the license (block 305, FIG. 3).

Given an element (content or journal) “Item ID” 1101, his license is controlled “Is free” 1102: if it is free it is possible to go ahead and skip to its detail “Item detail” 1103, otherwise it checks if the user already has an active license for that element “Already Purchased” 1104. If so the user can proceed to detail, if not it undergoes a preview of the “Item preview” 1105, from where the user is given the possibility to buy a license “Purchase” 1106 that may allow him to proceed to the detail.

In the following the technologies used in the platform are described.

All infrastructure components communicate with each other using the protocol HTTP REST (GET, PUT, POST and DELETE) and exchange the information mainly in JSON format where possible, otherwise directly in binary or other formats.

The components of the GUI (Frontend and Admin) are developed with conventional technologies such as HTML5, CSS3, JavaScript®, through the use of framework Ruby On Rails® based on the Ruby programming language.

The Image API are developed with the framework Ruby On Rails® and are supported by ImageMagick® for image manipulation.

The Crawler is developed in Java® 1.6/1.7, using known technologies such as Spring©/SpringMVC©, Quartz Scheduler®, Rome©, Boilerpipe©, Apache Commons®, NekoHTML©, HTMLCleaner©, JTidy©, MySQL®, MessageQueue Systems, NoSQL (MongoDB©, OrientDB®).

The Search API are developed in Java® 1.6/1.7, using known technologies such as Spring©/SpringMVC©, Apache Commons®, Apache Solr®/Apache Lucene®, message queue systems, MongoDB©, OrientDB®.

The Content API are developed in Java® 1.6/1.7, using known technologies such as Spring/SpringMVC, Hibernate©, Apache Commons®, message queue systems, MongoDB©, OrientDB®, MySQL®.

The SemanticIndexer is currently Cogito® of Expert Systems S.p.a.

All components are deployed on infrastructure of Amazon Web Services® to allow a scalable use on user requests.

Further implementation details will not be described, as the man skilled in the art is able to carry out the invention starting from the teaching of the above description.

Many changes, modifications, variations and other uses and applications of the subject invention will become apparent to those skilled in the art after considering the specification and the accompanying drawings which disclose preferred embodiments thereof. All such changes, modifications, variations and other uses and applications which do not depart from the scope of the invention are deemed to be covered by this invention.

The elements and characteristics described in the various forms of preferred embodiments can be mutually combined without departing from the scope of the invention.

What is claimed is:

1. An apparatus adapted for the handling, creation and distribution of multimedia aggregates, comprising:
a first database module, adapted to store and organize data for registered users, and to generate user profiles associated to each of said registered users;
a second database module, adapted to store multimedia content in a content database, and to associate content profiles to each of said multimedia content;
a first interface adapted for use of multimedia contents, and adapted to perform searches on said content database, to generate dynamic custom pages and/or static custom pages including said multimedia content, and including advertising contents associated with said multimedia content, said interface for use of contents allowing the publication or display of said dynamic custom pages or static custom pages created;
a second interface adapted for content creation, and adapted to let said multimedia content to be inserted in said content database, and assigned to said dynamic custom pages and/or static custom pages, said dynamic custom pages being updated automatically based on selection and sort criteria set by the user, said static custom pages being organized in specific selected sort order, position and size;
a third interface adapted for advertising entry and purchasing, and adapted to enter advertising content in said content database and insert advertising content in said dynamic custom pages and/or static custom pages on the basis of the result of an auction mechanism, said multimedia aggregates comprising said dynamic custom pages and/or static custom pages.

2. An apparatus as in claim 1, wherein it is adapted to categorize said users as:
users, as any of said registered users;
publishers, as any entity providing any of said multimedia content;
aggregators, as any entity creating said multimedia aggregates;
and wherein it is adapted to perform said auction mechanism on the basis of calculations of best reward offers and sharing of advertising revenue among said categories of users, publishers and aggregators, and a system manager.

3. An apparatus as in claim 2, wherein it is adapted to calculate said sharing of advertising revenue among said categories of users redistributing the advertising content through their own journals or by enabling readers to access the advertising content by using their user profile.

4. An apparatus as in claim 2, wherein said third interface is adapted to let said advertisers enter the advertising message, define target user profiles and content profiles to be matched with said user profiles and content profiles for insertion of the advertising, insert an offered reward for the publication of the advertising.

5. An apparatus as in claim 4, wherein said third interface is adapted to perform said auction mechanism among a set of advertisements matching between said target user profiles and content profiles, and said user profiles and content profiles, and selecting the one offering the highest reward.

6. An apparatus as in claim 1, wherein it is adapted to generate said user profiles by operations of behavioral analysis of content selection and search actions, text and semantic analysis, navigation preferences, and said content profiles are generated by operations of automatic indexing based on semantic analysis and full-text analysis, said user profiles and content profiles being used for the generation of said dynamic and static custom pages.

7. An apparatus as in claim 6, wherein, for generation of said user and content profiles, it is adapted to perform calculations of similarity between users; similarity between users and content; similarity between content, said similarities comprise vector numerical calculation of n-dimensional differences or distances.

8. An apparatus as in claim 1, wherein it is adapted to perform said searches on the content database by a two-step procedure of first filtering content through parameters, then boosting the filtering by sorting by a ranking of importance of various selected content.

9. An apparatus as in claim 1, wherein said second interface is adapted to enter said content into the content database by:
direct insertion by a user;
references of external addresses made available to connect with to recover the contents in full or in part;
connections to proprietary databases to download content.

10. An apparatus as in claim 1, wherein it is adapted to generate, for each registered user, a standard journal associated to said user, as a starting default multimedia aggregate, containing first multimedia contents.

11. A method for the handling, creation and distribution of multimedia aggregates, comprising the steps of:
providing a first database module, to store and organize data for registered users, and to generate user profiles associated to each of said registered users;
providing a second database module, to store multimedia content in a content database, and to associate content profiles to each of said multimedia content;
providing a first interface for use of multimedia contents, to perform searches on said content database, to generate dynamic custom pages and/or static custom pages including said multimedia content, and including advertising contents associated with said multimedia content, said interface for use of contents allowing the publication or display of said dynamic custom pages and/or static custom pages created;
providing a second interface for content creation, to let said multimedia content to be inserted in said content database, and assigned to said dynamic custom pages and/or static custom pages, said dynamic custom pages being updated automatically based on selection and sort criteria set by the user, said static custom pages being organized in specific selected sort order, position and size;
providing a third interface for advertising entry and purchasing, to enter advertising content in said content database and insert advertising content in said dynamic custom pages and/or static custom pages on the basis of the result of an auction mechanism, said multimedia aggregates comprising said dynamic custom pages and/or static custom pages.

12. A method as in claim 11, wherein it comprises the steps of:
categorizing said users as:
users, as any of said registered users;
publishers, as any entity providing any of said multimedia content;
aggregators, as any entity creating said multimedia aggregates;
and performing said auction mechanism on the basis of calculations of best reward offers and sharing of advertising revenue among said categories of users, publishers, aggregators and a system manager.

13. A method as in claim 12, wherein said calculation of sharing of advertising revenue is performed among said categories of users redistributing the advertising content through their own journals or by enabling readers to access the advertising content by using their user profile.

14. A method as in claim 11, wherein it comprises the steps of enter the advertising message, define target user profiles and content profiles to be matched with said user profiles and content profiles for insertion of the advertising, insert an offered reward for the publication of the advertising.

15. A method as in claim 11, wherein it comprises the steps of performing said auction mechanism among a set of advertisements matching between said target user profiles and content profiles, and said user profiles and content profiles, and selecting the one offering the highest reward.

16. A method as in claim 11, wherein it comprises the steps of generating said user profiles by operations of behavioral analysis of content selection and search actions, text and semantic analysis, navigation preferences, and generating said content profiles by operations of automatic indexing based on semantic analysis and full-text analysis, said user profiles and content profiles being used for the generation of said dynamic and/or static custom pages.

17. A method as in claim 11, wherein, for generation of said user and content profiles, it performs calculations of similarity between users; similarity between users and content; similarity between content, said similarities comprise vector numerical calculation of n-dimensional differences or distances.

18. A method as in claim 11, wherein it comprises performing said searches on the content database by a two-step procedure of first filtering content through parameters, then boosting the filtering by sorting by a ranking of importance of various selected content.

19. A method as in claim 11, wherein it comprises to enter said content into the content database by:
direct insertion by a user;
references of external addresses made available to connect with to recover the contents in full or in part;
connections to proprietary databases to download content.

20. A method as in claim 11, wherein it comprises a step of generation, for each registered user, of a standard journal associated to said user, as a starting default multimedia aggregate, containing first multimedia contents.
